(19) United States
(12) Patent Application Publication
(10) Pub. No.: US 2012/0147180 A1
(43) Pub. Date: Jun. 14, 2012

(54) METHOD AND SYSTEM FOR PROVIDING INTERFACE COMPATIBILITY BETWEEN DEVICES IN SYSTEM

(75) Inventors: Hong Il JU, Daejeon (KR); Geonwoo KIM, Daejeon (KR); Min-ho HAN, Daejeon (KR); Jin Hee HAN, Daejeon (KR); SuGil CHOI, Daejeon (KR); Su Wan PARK, Daejeon (KR); Yong-Sung JEON, Daejeon (KR); Moo Seop KIM, Daejeon (KR); Young Sae KIM, Daejeon (KR); Jong-Wook HAN, Daejeon (KR)

(73) Assignee: Electronics and Telecommunications Research Institute, Daejeon (KR)

(21) Appl. No.: 13/314,429

(22) Filed: Dec. 8, 2011

(30) Foreign Application Priority Data
Dec. 13, 2010 (KR) 10-2010-0127082

(51) Int. Cl. H04N 7/18

(52) U.S. Cl. 348/143; 348/E07.085

(57) ABSTRACT

A video surveillance system provides interface compatibility. The system includes a plurality of security devices connected to a network and configured to collect video data, a security server configured to make a connection request to a target security device to monitor the video data collected by the target security device, and an interface conversion server configured to convert the connection request in conformity to an interface of the target security device. The interface conversion server is further configured to convert the video data collected by the target security device having a non-standard interface in conformity to a standard interface in order for the security server to monitor the collected video data.

### CROSS-REFERENCE TO RELATED APPLICATION(S)

The present invention claims priority of Korean Patent Application No. 10-2010-0127082, filed on Dec. 13, 2010, which is incorporated herein by reference.

### FIELD OF THE INVENTION

The present invention relates to a video surveillance system, and more particularly, to an apparatus and method for providing interface compatibility between security devices having different interfaces in a video surveillance system.

### BACKGROUND OF THE INVENTION

Currently, the camera market is being switched from existing analog cameras to network cameras, and both markets coexist. Therefore, with the appearance of the network cameras, a user may access a network to monitor video data collected by the network camera, when the user may access the network anytime and anywhere.

In a video surveillance system configured via a network, however, security devices such as the network cameras developed by a variety of manufacturers have different interfaces from one another, and use protocols developed by their own manufacturers. Such a problem makes it difficult to perform an interworking operation between the security devices developed by different manufacturers. For example, in order to simultaneously monitor and control videos collected by network cameras connected through a network, it is preferably for the video surveillance system to use security devices manufactured by the same manufacturer and having the same interface. Therefore, one common standard interface is defined to solve such a problem, and products having the common interface mounted therein are launched on the market.

However, since the products having the standard interface mounted therein are newly-manufactured products, the security devices having unique interfaces of the respective manufacturers in the existing video surveillance system cannot interwork with the security devices having the standard interface mounted therein. Due to that, all the security devices installed in the existing video surveillance system should be replaced with new ones having the standard interface mounted therein.

### SUMMARY OF THE INVENTION

In view of the above, the present invention provides an apparatus and method for providing interface compatibility between security devices having different interfaces in a video surveillance system.

In accordance with a first aspect of the present invention, there is provided a video surveillance system for providing interface compatibility, the system comprising:

a plurality of security devices connected to a network and configured to collect video data;

a security server configured to make a connection request to a target security device to monitor the video data collected by the target security device; and

an interface conversion server configured to convert the connection request in conformity to an interface of the target security device.

Preferably, the interface conversion server includes:

a device management unit configured to manage information on whether each of the security devices has a standard interface or a non-standard interface mounted therein; and

an interface conversion unit configured to convert the connection request to the target security device in conformity to the standard interface of the target security device, based on the interface information managed by the device management unit.

Preferably, the interface conversion server further comprises a device connection unit configured to connect the target security device and the security server in accordance with the converted connection request.

Preferably, the interface conversion unit is further configured to convert the video data collected by the target security device in conformity to the standard interface in order for the security server to monitor the collected video data.

In accordance with a second aspect of the present invention, there is provided an interface conversion server for use in a video surveillance system having a security server and a plurality of security devices, comprising:

a device management unit configured to manage information on whether each of the security devices has a standard interface or a non-standard interface mounted therein; and

an interface conversion unit configured to convert a connection request from the security server to a target security device in conformity to the interface of the target security device, based on the interface information managed by the device management unit.

Preferably, the interface conversion unit is further configured to convert video data collected by the target security device in conformity to the standard interface in order for the security server to monitor the collected video data.

In accordance with a third aspect of the present invention, there is provided a method for providing interface compatibility in a video surveillance system connected to a network, the video surveillance including a security server and a plurality of security devices having a standard interface or non-standard interface, the method including:

upon receiving a connection request to a target security device in order for the security server to monitor video data collected by the target security device, checking information on an interface of the target security device;

converting the connection request in conformity to the interface of the target security device; and

connecting the target security device to the requesting device in accordance with the converted connection request.

Preferably, the method further includes:

converting the collected vided data from the target security device in conformity to the standard interface to provide the converted video data to the security server.

The method further includes:

upon receiving a connection request to a target security device in order for another security device to store therein video data collected by the target security device, converting the connection request in conformity to the interface of the target security device;

connecting the target security device to the another security device in accordance with the converted connection request; and

converting the collected vided data from the target security device in conformity to the interface of the another security device to provide the converted video data to the another security device.

Preferably, the method further includes:

when a new security device is connected to the network, checking an interface mounted in the new security device; and

registering information on the checked interface.

### BRIEF DESCRIPTION OF THE DRAWINGS

The above and other objects and features of the present invention will become apparent from the following description of embodiments given in conjunction with the accompanying drawings, in which:

FIG. 1 is a block diagram of a video surveillance system in accordance with an embodiment of the present invention;

FIG. 2 is a detailed block diagram of an interface conversion server shown in FIG. 1; and

FIG. 3 is a flow chart illustrating the operation of the security system shown in FIG. 1.

### DETAILED DESCRIPTION OF THE EMBODIMENTS

Hereinafter, embodiments of the present invention will be described in detail with reference to the accompanying drawings so that they can be readily implemented by those skilled in the art.

FIG. 1 is a block diagram of a video surveillance system in accordance with an embodiment of the present invention.

The video surveillance system includes a plurality of security devices 120 and 130, a security server 100, and an interface conversion server 200, all of which are connected to an IP-based network 150, e.g., the Internet.

Each of the security devices 120 and 130 collects video data captured in a surveillance area to provide the collected video data to the security server 100 or another security device through the network 150. The security device 120 may include a network camera (also referred to as Internet camera or IP (Internet Protocol) camera) and a video server such as a digital video recorder (DVR) and a network video recorder (NVR). The security devices 120 and 130 may be manufactured by different manufacturers and thus may have a standard interface or non-standard interface mounted therein. For a simple explanation, hereinafter, it is assumed that the security device 120 has a standard interface and the security device 130 has a non-standard interface.

The security server 100 serves as a client of monitoring the collected video data by the security devices 120 and 130. In addition, the security server 100 may perform a function of storing and managing the collected video data and a function of controlling and managing the security devices 120 and 130. The security server 100 has a standard interface mounted therein and controls and manages the security devices 120 and 130 based on the mounted standard interface.

Upon a receipt of a connection request to a target security device 120 or 130 from the security server 100, the interface conversion server 200 enables the target security device 120 or 130 to connect the security server 100 regardless of the interface of the security device and the security server. For example, in case where the security device 130 has a non-standard interface, the interface conversion server 200 performs interface conversion by which the connection request from the security server 100 is converted to conform to the non-standard interface of the security device 120, so that the security device 130 having the non-standard interface can be connect to the security server 100.

In other words, in order for the connection of the security device 120 having the standard interface mounted therein to the security server 100, the interface conversion server 200 connects the security device 120 to the security server 100, without performing the interface conversion. Meanwhile, in order for the connection of the security device 130 having the non-standard interface mounted therein to the security server 100, the interface conversion server 200 performs the interface conversion by which the connection request from the security server 100 is converted to conform to the non-standard interface of the security device 130. After the connection between the security server 100 and the security device 130, the collected video data from the security device 130 is converted to conform to the standard interface of the security server 100.

By virtue of the interface conversion server 200 in accordance with the embodiment of the present invention, the security devices 130 having the non-standard interface can interwork with the security server 100, thereby achieving interface compatibility and interoperability between the devices in the video surveillance system.

In the embodiment of the present invention, it has been shown and described that the interface conversion server 200 is provided separately from the security server 100. Alternatively, it will be appreciated to those skilled in the art that the function of the interface conversion server 200 may be partially included in the security server 100.

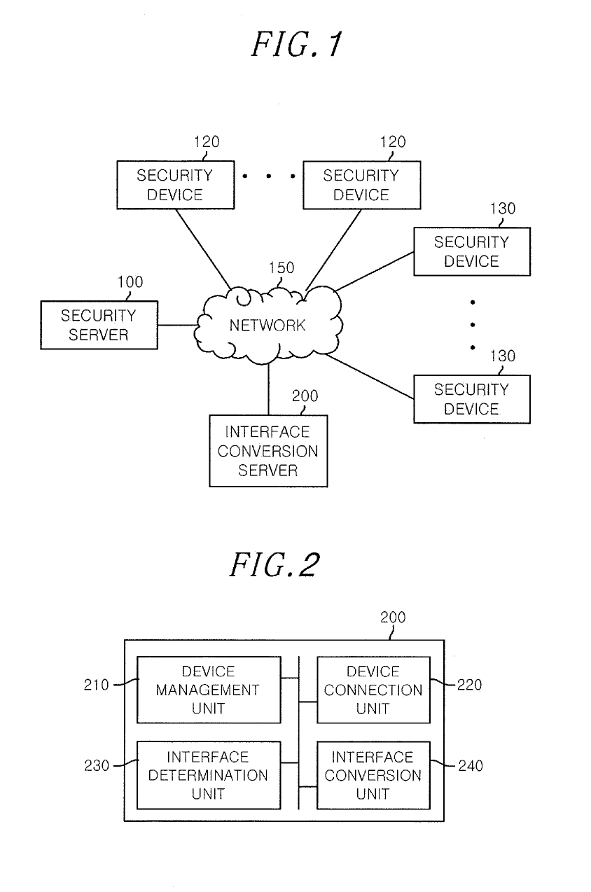

FIG. 2 is a detailed block diagram of the interface conversion server shown in FIG. 1.

The interface conversion server 200 includes a device management unit 210, a device connection unit 220, an interface determination unit 230, and an interface conversion unit 240.

The device management unit 210 is configured to manage the security devices 120 and 130 connected through the network. In other words, the device management unit 210 manages information on whether or not each security device 120 and 130 supports the standard interface and information on a unique interface for each manufacturer.

For a security device 130 having the non-standard interface mounted therein, a unique interface of the security device 130 needs to be registered in the device management unit 210 in advance.

The interface determination unit 230 is configured to request the interface information from a target security device from the device management unit 210. Upon receiving the interface information, the interface determination unit 230 determines whether or not the target security device supports the standard interface, that is, whether or not the target security device has the standard interface or the non-standard interface. The determination result by the interface determination unit 230 is provided to the interface conversion unit 240 and the device connection unit 220.

The interface conversion unit 240 is configured to receive a connection request to a target security device from another security device 100 or to a target security device from the security server 100, and perform convert the connection request in conformity to the interface of the target security device.

The device connection unit 220 is configured to make a connection between the security devices or a connection between the security device and the security server 100 in accordance with the converted connection request.

For example, when a connection request to the target security device 130 having a non-standard interface is made from the security server 100, the interface conversion unit 240 converts the connection request in conformity to the non-standard interface of the target security device 130.

Meanwhile, when two security devices has different non-standard interfaces, e.g., first and second interfaces, respectively, the interface conversion unit 240 converts a connection request from the security device having the first (or the second) interface in conformity to the second (or the first) interface of the second (or the first) security device, and converts video data of the second (or the first) security device having the second interface (or the first) in conformity to the first interface (or the second) of the security device.

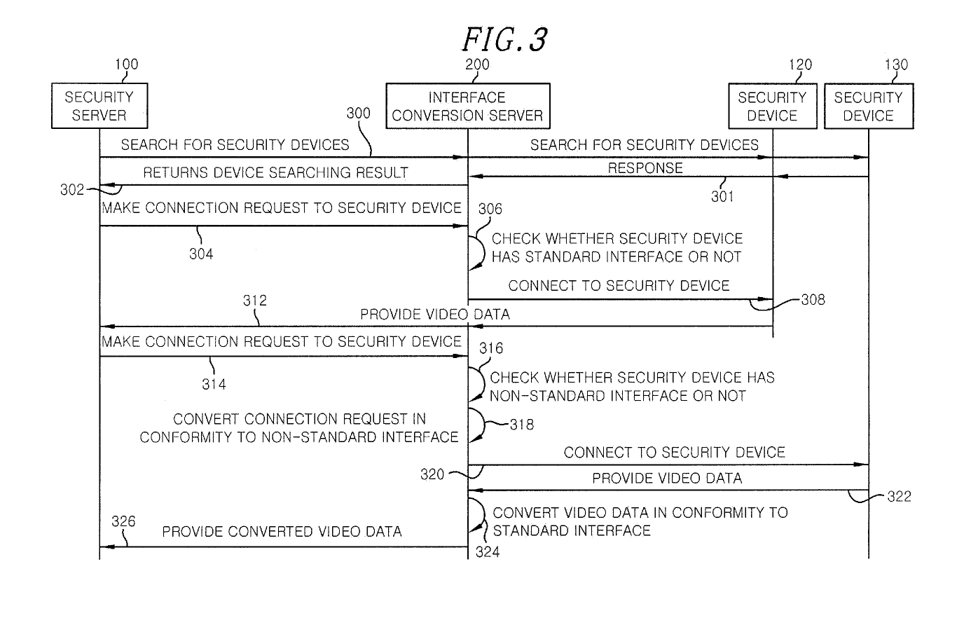

The operation of the interface conversion server 200 having the above-described configuration will be described with reference to FIG. 3.

FIG. 3 is a flow chart illustrating the operation of the security system in FIG. 1 in accordance with the embodiment of the present invention.

First, in step 300, the security server 100 makes a connection request to the interface conversion server 200 to search for the security devices 120 and 130 connected to the network.

Next, the interface conversion server 200 collects responses from the security devices connected to the network in step 301 and returns a device searching result to the security server 100 in step 302.

In step 304, the security server 100 may make a connection request to the security device 120 having the standard interface mounted therein to the interface conversion server 200, based on the device searching result.

In step 306, the interface conversion server 200 checks whether the security device 120 has the standard interface from the device management unit 210. After checking the interface of the security device 120, in step 308, the interface conversion server 200 immediately connects the security server 100 to the security device 120 having the standard interface.

The interface conversion server 200 receives collected video data from the security device 120 in step 310, and provides the collected video data to the security server 100 in order for the security server 100 to monitor the collected video data in step 312.

Meanwhile, when the security server 100 requires obtaining collected video data from the security device 130 having the non-standard interface mounted therein, it makes a connection request to the interface conversion server 200 in step S314.

Thereafter, in step 316, the interface conversion server 200 checks whether the interface of the security device 130 is the standard interface or a non-standard interface, through the device management unit 210.

As a check result, when the security device 130 has the non-standard interface, the interface conversion server 200 converts the connection request in conformity to the non-standard interface of the security device 130 through the interface conversion unit 240 in step 318, and then connects the security device 130 to the security server 100 in step 320.

Thereafter, in step 322, the security device 130 provides the collected video data to the interface conversion server 200.

Subsequently, in step 324, the interface conversion server 200 converts the collected video data received from the security device 130 in conformity to the standard interface through the use of the interface conversion unit 240, and, in step 326, transmits the converted video data to the security server 100 in order for the security server 100 to monitor the collected video data.

In accordance with the embodiment of the present invention, the interface conversion server 200 enables the interworking operation between the security devices 120 having a non-standard interface and the security server 100. Therefore, it is possible to construct the video surveillance system, without replacing the security devices having non-standard interface with new products having the standard interface.

While the invention has been shown and described with respect to the preferred embodiments, it will be understood by those skilled in the art that various changes and modifications may be made without departing from the scope of the invention as defined in the following claims.

What is claimed is:

1. A video surveillance system for providing interface compatibility, the system comprising:
a plurality of security devices connected to a network and configured to collect video data;
a security server configured to make a connection request to a target security device to monitor the video data collected by the target security device; and
an interface conversion server configured to convert the connection request in conformity to an interface of the target security device.

2. The system of claim 1, wherein the interface conversion server comprises:
a device management unit configured to manage information on whether each of the security devices has a standard interface or a non-standard interface; and
an interface conversion unit configured to convert the connection request to the target security device in conformity to the interface of the target security device, based on the interface information managed by the device management unit.

3. The system of claim 2, wherein the interface conversion server further comprises a device connection unit configured to connect the target security device and the security server in accordance with the converted connection request.

4. The system of claim 2, wherein the interface conversion unit is further configured to convert the video data collected by the target security device in conformity to the standard interface in order for the security server to monitor the collected video data.

5. An interface conversion server for use in a video surveillance system having a security server and a plurality of security devices, comprising:
a device management unit configured to manage information on whether each of the security devices has a standard interface or a non-standard interface; and
an interface conversion unit configured to convert a connection request from the security server to a target security device in conformity to the interface of the target security device, based on the interface information managed by the device management unit.

6. The interface conversion server of claim 5, wherein the interface conversion unit is further configured to convert video data collected by the target security device in conformity to the standard interface in order for the security server to monitor the collected video data.

7. A method for providing interface compatibility in a video surveillance system connected to a network, the video surveillance including a security server and a plurality of security devices having a standard interface or non-standard interface, the method comprising:
upon receiving a connection request to a target security device in order for the security server to monitor video data collected by the target security device, checking information on an interface of the target security device;
converting the connection request in conformity to the interface of the target security device; and
connecting the target security device to the security server in accordance with the converted connection request.

8. The method of claim 7, further comprising:
converting the collected vided data from the target security device in conformity to the standard interface to provide the converted video data to the security server.

9. The method of claim 7, further comprising:
upon receiving a connection request to a target security device in order for another security device to store therein video data collected by the target security device, converting the connection request in conformity to the interface of the target security device;
connecting the target security device to the another security device in accordance with the converted connection request; and
converting the collected vided data from the target security device in conformity to the interface of the another security device to provide the converted video data to the another security device.

10. The method of claim 7, further comprising:
when a new security device is connected to the network, checking an interface mounted in the new security device; and
registering information on the checked interface.
